(19) United States
(12) Patent Application Publication
(10) Pub. No.: US 2023/0147594 A1
(43) Pub. Date: May 11, 2023

(54) METHOD FOR INTEGRATEDLY UPDATING MAP DATA, DEVICE AND STORAGE MEDIUM

(71) Applicant: Beijing Baidu Netcom Science Technology Co., Ltd., Beijing (CN)

(72) Inventors: Deguo XIA, Beijing (CN); Hongfei ZHU, Beijing (CN); Yaqian SHEN, Beijing (CN); Jiaqi LIU, Beijing (CN); Yuting LIU, Beijing (CN)

(21) Appl. No.: 18/150,994

(22) Filed: Jan. 6, 2023

(30) Foreign Application Priority Data
May 17, 2022 (CN) 202210540988.5

(51) Int. Cl. G01C 21/00

(52) U.S. Cl. CPC G01C 21/3815

(57) ABSTRACT

The present disclosure provides a method for integratedly updating map data, a device, and a storage medium, relates to the field of artificial intelligence technology such as vehicle-road coordination and intelligent transportation. An embodiment of the method includes: acquiring map update data; generating an updated confidence of map features based on the map update data; and updating uniformly a first-precision map and a second-precision map based on the updated confidence of the map features, where precision of the first-precision map is higher than precision of the second-precision map.

### CROSS-REFERENCE TO RELATED APPLICATION

The present application claims the priority of Chinese Patent Application No. 202210540988.5, titled “METHOD AND APPARATUS FOR INTEGRATEDLY UPDATING MAP DATA, DEVICE AND STORAGE MEDIUM”, filed on May 17, 2022, the content of which is incorporated herein by reference in its entirety.

### TECHNICAL FIELD

The present disclosure relates to the field of artificial intelligence technology such as vehicle-road coordination and intelligent transportation.

### BACKGROUND

Intelligent transportation has come into a critical period of rapid development. Intelligent transportation requires maps with different precision as the cornerstone. With the continuous evolution of vehicle-road coordination, higher and higher requirements have been put forward for maps. Maps with different precision must ensure high coverage and fast timeliness.

At present, maps with different precision are independent of each other, and only original collected data are interconnected, and the maps with different precision need to be updated separately.

### SUMMARY

Embodiments of the present disclosure propose a method for integratedly updating map data, a device, and a storage medium.

According to a first aspect, embodiments of the present disclosure propose a method for integratedly updating map data, the method includes: acquiring map update data; generating an updated confidence of map features based on the map update data; and updating uniformly a first-precision map and a second-precision map based on the updated confidence of the map features, where precision of the first-precision map is higher than precision of the second-precision map.

According to a second aspect, embodiments of the present disclosure propose an electronic device, and the device includes: at least one processor; and a memory communicatively connected to the at least one processor; where the memory stores instructions executable by the at least one processor, and the instructions, when executed by the at least one processor, cause the at least one processor to perform the method as described in any implementations of the first aspect.

According to a third aspect, embodiments of the present disclosure propose a non-transitory computer readable storage medium storing computer instructions, where the computer instructions, when executed by a computer, cause the computer to perform the method as described in any implementations of the first aspect.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

After reading detailed description of non-limiting embodiments with reference to the following accompanying drawings, other features, objectives, and advantages of the present disclosure will become more apparent. The accompanying drawings are used to better understand this solution and do not constitute a limitation to the present disclosure.

FIG. 1 is a flowchart of an embodiment of a method for integratedly updating map data according to the present disclosure;

FIG. 2 is a flowchart of another embodiment of the method for integratedly updating map data according to the present disclosure;

FIG. 3 is a scenario diagram in which the method for integratedly updating map data according to an embodiment of the present disclosure may be implemented;

FIG. 4 is a flowchart of another embodiment of the method for integratedly updating map data according to the present disclosure;

FIG. 5 is another scenario diagram in which the method for integratedly updating map data according to an embodiment of the present disclosure may be implemented;

FIG. 6 is yet another scenario diagram in which the method for integratedly updating map data according to an embodiment of the present disclosure may be implemented;

FIG. 7 is a schematic structural diagram of an embodiment of an apparatus for integratedly updating map data according to the present disclosure; and

FIG. 8 is a block diagram of an electronic device used to implement the method for integratedly updating map data according to an embodiment of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skill in the art should realize that various changes and modifications can be made to the embodiments described here without departing from the scope and spirit of the present disclosure. Similarly, for clearness and conciseness, description of well-known functions and structures is omitted in the following description.

It should be noted that the embodiments of the present disclosure and features in the embodiments may be combined with each other on a non-conflict basis. The present disclosure will be described in detail with reference to the accompanying drawings and in conjunction with the embodiments.

FIG. 1 illustrates a flow 100 of an embodiment of a method for integratedly updating map data according to the present disclosure. The method for integratedly updating map data includes the following steps:

Step 101, acquiring map update data.

In the present embodiment, an executing body of the method for integratedly updating map data may acquire the map update data. The map update data may be data for updating a map. There are various sources for the map update data, and precision of map update data originating from different sources may be different. Typically, the map update data may include, but is not limited to, high-precision point cloud data, low-precision crowdsourced collection data, or the like.

Step 102, generating an updated confidence of map features based on the map update data.

In the present embodiment, the executing body may generate the updated confidence of the map features based on the map update data. The map features may be main factors on a map. Using lane information as an example, the map features may include, but are not limited to, bounding boxes, turning arrows, lane types, time periods, number of lanes, and associated roads, etc. Bounding boxes may be enclosed rectangular borders of turning arrows, which are used to express spatial information. There are constant changes in the real world, and data update time, change occurrence time, and the latest coverage data precision together constitute base conditions for confidence determination. The confidence can not only express the latest changes, but also distinguish the precision and timeliness reliability of different layers. The confidence may directly act on specific attributes of map features, including but not limited to precision confidence and timeliness confidence, and so on.

Step 103, updating uniformly a first-precision map and a second-precision map based on the updated confidence of the map features.

In the present embodiment, the executing body may update uniformly the first-precision map and the second-precision map based on the updated confidence of the map features. Specifically, it may be determined whether to modify the first-precision map and the second-precision map based on changes in the map features, and the updated confidence of the map features is labeled on the first-precision map and the second-precision map. Here, the precision of the first-precision map may be higher than the precision of the second-precision map. Therefore, the first-precision map may also be referred to as a high-precision map, and the high-precision map may include a lane-level map. The second-precision map may also be referred to as a standard map.

The method for integratedly updating map data provided by embodiments of the present disclosure proposes a data update solution based on “one map”. By building a confidence system, maps with different precision can be integratedly updated, which not only ensures data consistency, but also reduces data processing costs.

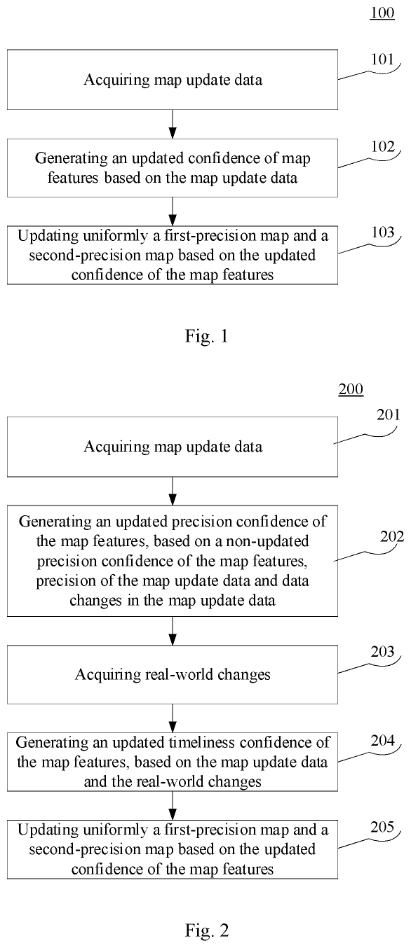

With further reference to FIG. 2, FIG. 2 illustrates a flow 200 of another embodiment of the method for integratedly updating map data according to the present disclosure. The confidence in the method for integratedly updating map data includes a precision confidence and a timeliness confidence. The method for integratedly updating map data includes the following steps:

Step 201, acquiring map update data.

In the present embodiment, the specific operation of step 201 has been described in detail in step 101 in the embodiment shown in FIG. 1, and detailed description thereof will be omitted.

Step 202, generating an updated precision confidence of the map features, based on a non-updated precision confidence of the map features, precision of the map update data and data changes in the map update data.

In the present embodiment, the executing body of the method for integratedly updating map data may generate the updated precision confidence of the map features, based on the non-updated precision confidence of the map features, the precision of the map update data and the data changes in the map update data.

First, dependence of different map features on data precision needs to be clarified. Using lane information as an example, only the update of bounding boxes needs to rely on high-precision data. Turning arrows, lane types, time periods, number of lanes, and associated roads may be updated by either low-precision data or high-precision data.

The update of the precision confidence is affected by multiple factors, and is a result of a combined effect of the non-updated precision confidence of the map features, the precision of the map update data, and the data changes in the map update data. Using a scenario of the number of lanes as an example, the following table lists maintenance results of the precision confidence:

| | Non-updated | Whether the | |
|---|---|---|---|
| Data | precision | number of | Maintenance result of the |
| precision | confidence | lanes changes | precision confidence |
| High | Low | No | Maintain data precision + |
| precision | confidence | | high confidence |
| High | Low | Yes | Modify data + high |
| precision | confidence | | confidence |
| High | High | No | High confidence |
| precision | confidence | | |
| High | High | Yes | Modify data + high |
| precision | confidence | | confidence |
| Low | Low | No | Low confidence |
| precision | confidence | | |
| Low | Low | Yes | Modify data + low |
| precision | confidence | | confidence |
| Low | High | No | High confidence |
| precision | confidence | | |
| Low | High | Yes | Modify data + low |
| precision | confidence | | confidence |

Step 203, acquiring real-world changes.

In the present embodiment, since the timeliness confidence reflects whether the content of the map update data is consistent with the real world, the executing body may acquire the real-world changes.

Step 204, generating an updated timeliness confidence of the map features, based on the map update data and the real-world changes.

In the present embodiment, the executing body may generate the updated timeliness confidence of the map features, based on the map update data and the real-world changes.

Typically, if the content of the map update data is consistent with the real-world changes, it may be expressed by marking the timeliness confidence as a high confidence; if the content of the map update data is not consistent with the real-world changes, it may be expressed by marking the timeliness confidence as a low confidence. There is a scenario where when the map update data is input, real-world changes are found, but the data cannot be updated. At this time the timeliness confidence needs to be marked as a low confidence. For example, lane information data is expressed as straight, straight, straight, and the scene changes. Because of data overlay, it can only be judged that the right lane is not a straight lane, may be a right turn or a straight plus right turn, and the map data cannot be updated directly. In this regard, it is necessary to express by confidence, and the timeliness confidence is marked as a low confidence.

Step 205, updating uniformly a first-precision map and a second-precision map based on the updated confidence of the map features.

In the present embodiment, the specific operation of step 205 has been described in detail in step 103 in the embodiment shown in FIG. 1, and detailed description thereof will be omitted.

As can be seen from FIG. 2, compared with the corresponding embodiment in FIG. 1, the flow 200 of the method for integratedly updating map data in the present embodiment highlights the confidence generation step. Thus, the solution described in the present embodiment divides the confidence into two dimensions: precision and timeliness. The confidence can not only express the latest changes, but also distinguish the precision and timeliness reliability of different layers.

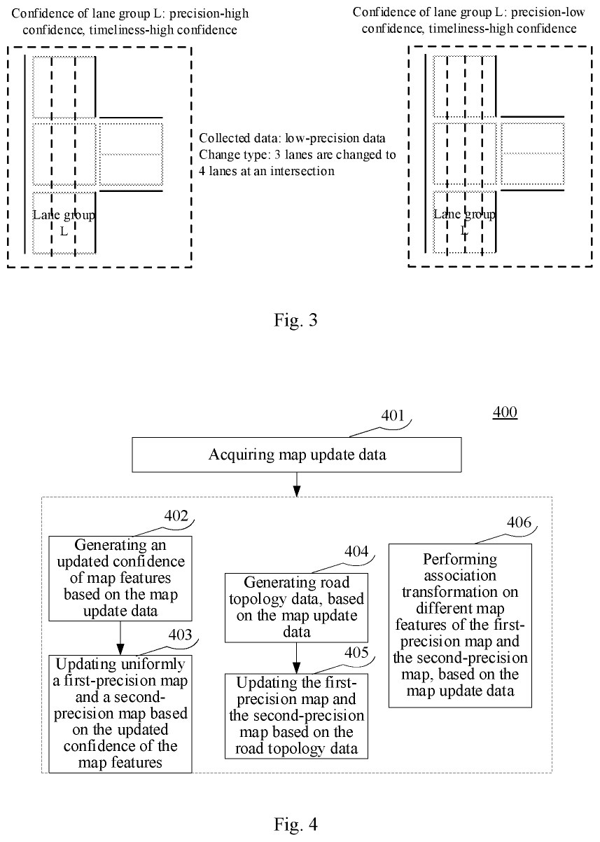

For ease of understanding, FIG. 3 illustrates a scenario diagram in which the method for integratedly updating map data according to an embodiment of the present disclosure may be implemented. As shown in FIG. 3, a non-updated confidence of a lane group L of a high-precision map is a precision-high confidence and a timeliness-high confidence. Collected data is low-precision data, and a change type is that 3 lanes are changed to 4 lanes at an intersection. Based on the collected data, update is performed, and an updated confidence of the lane group L of the updated high-precision map is a precision-low confidence and timeliness-high confidence.

With further reference to FIG. 4, FIG. 4 illustrates a flow 400 of another embodiment of the method for integratedly updating map data according to the present disclosure. The method for integratedly updating map data includes the following steps:

Step 401, acquiring map update data.

Step 402, generating an updated confidence of map features based on the map update data.

Step 403, updating uniformly a first-precision map and a second-precision map based on the updated confidence of the map features.

In the present embodiment, the specific operations of steps 401-403 have been described in detail in steps 101-103 in the embodiment shown in FIG. 1, and detailed description thereof will be omitted.

Step 404, generating road topology data, based on the map update data.

In the present embodiment, the executing body of the method for integratedly updating map data may generate the road topology data, based on the map update data. Here, road topology may be basic elements that forms a map. Typically, the second-precision map may be expressed by a simple point-line model, and the first-precision map may be expressed by lane group data consisting of lane demarcation lines and lane boundary lines, which is richer in information and more accurate.

Step 405, updating the first-precision map and the second-precision map based on the road topology data.

In the present embodiment, the executing body may update the first-precision map and the second-precision map based on the road topology data. Typically, one piece of map update data may automatically output different layers of data through one processing. Based on topology automation technology, combined with a small amount of manual and semi-automatic interaction, topology maintenance may be completed efficiently.

In addition to solving the problem of data consistency and quality, the integratedly update flow may also realize the automatic output of different layers of data through one processing for one piece of data. Based on topology automation technology, an automation rate of more than 90% may be achieved, combined with a small amount of manual and semi-automatic interaction, topology maintenance may be completed efficiently.

In some alternative implementations of the present embodiment, key steps of topology transformation may include:

first, performing intersection segmentation based on the road topology data, and connecting adjacent lane groups in series to form a conversion chain.

Then, extracting geometric information of lane centerlines from the lane groups within the conversion chain, to generate a road fitting line of the second-precision map. In addition, smoothing processing may alternatively be performed.

Next, associating an identification of a non-updated road segment of the second-precision map to the road fitting line. Typically, in reality, a road may be made into several segments on the second-precision map, and each segment is referred to as a road segment.

Then, linking an intersection connection relationship of the road fitting line in combination with intersection information.

Finally, restoring information of at least part of map features of the second-precision map to the road fitting line. For example, there is traffic restriction information at an intersection on the second-precision map. After topology transformation, the corresponding traffic restriction needs to be restored to a fitting road network.

Step 406, performing association transformation on different map features of the first-precision map and the second-precision map, based on the map update data.

In the present embodiment, the executing body may perform association transformation on the different map features of the first-precision map and the second-precision map, based on the map update data. Typically, data production may adopt a feature-based production model. In addition to solving the one-time processing between different layers, the integratedly update flow may also realize the association transformation between different features, which greatly saves labor costs.

In some alternative implementations of the present embodiment, the map features may include lane-level topology-associated features and lane-level attribute features. The lane-level attribute features may include a lane-level speed limit and/or a lane-level marking style. Further, map feature association transformation may be divided into two categories: lane-level topology-associated feature transformation and lane-level attribute feature transformation.

For the lane-level topology-associated feature transformation, lane information is used as an example. When data is updated to maintain the lane information, a connection relationship between lanes may be generated based on directional arrows in the map update data.

For the lane-level attribute feature transformation, the lane-level speed limit is used as an example, in the integrated flow, a first lane-level speed limit and a second lane-level speed limit of the first-precision map is generated based on a lane-level speed limit standard, and a first road-level speed limit of the second-precision map is generated based on the first lane-level speed limit and the second lane-level speed limit. The first lane-level speed limit may be an upper limit of the lane-level speed limit, also referred to as a lane maximum speed limit. The second lane-level speed limit may be a lower limit of the lane-level speed limit, also referred to as a lane minimum speed limit. The first road-level speed limit may be an upper limit of a road-level speed limit, also referred to as a road-level maximum speed limit.

For the lane-level attribute feature transformation, the lane-level marking style is used as an example, traffic restrictions may be generated in combination with road network topology, and the lane-level marking style may be generated based on the traffic restrictions.

As can be seen from FIG. 4, compared with the corresponding embodiment in FIG. 1, the flow 400 of the method for integratedly updating map data in the present embodiment adds topology transformation steps and associated feature maintenance steps. Thus, the solution described in the present embodiment combines the confidence system, topology automation, and integrated maintenance of associated features to update the map. The confidence system may ensure data accuracy, topology automation and integrated maintenance of associated features may achieve more than 90% automation, and data consistency may be ensured with only a small amount of labor.

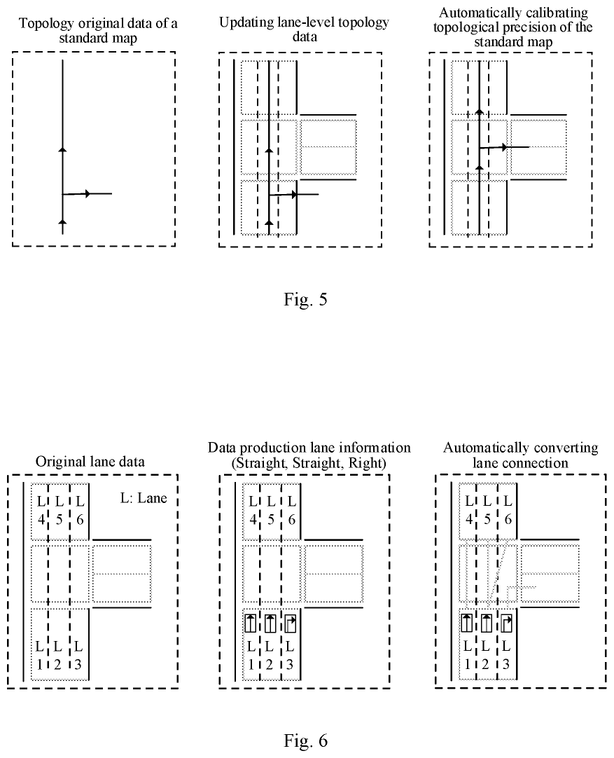

For ease of understanding, FIG. 5 illustrates another scenario diagram in which the method for integratedly updating map data according to an embodiment of the present disclosure may be implemented. As shown in FIG. 5, first, based on map update data, original topology data of a standard map is generated. Then, based on the original topology data of the standard map, lane-level topology data is updated. Finally, a topological precision of the standard map is automatically calibrated.

For ease of understanding, FIG. 6 illustrates yet another scenario diagram in which the method for integratedly updating map data according to an embodiment of the present disclosure may be implemented. As shown in FIG. 6, original lane data includes Lane 1, Lane 2, Lane 3, Lane 4, Lane 5, and Lane 6. Data production lane information is Lane 1-straight, Lane 2-straight, and Lane 3-right. Furthermore, lane connection is automatically converted into: Lane 1 connects Lane 4; Lane 2 connects Lane 5 and Lane 6; Lane 3 connects the right lane.

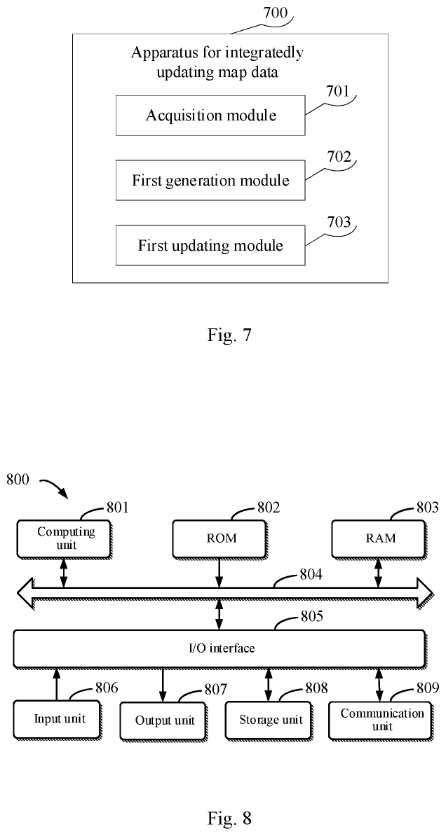

With further reference to FIG. 7, as an implementation of the method shown in the above figures, the present disclosure provides an embodiment of an apparatus for integratedly updating map data, and the apparatus embodiment corresponds to the method embodiment shown in FIG. 1. The apparatus may be applied to various electronic devices.

As shown in FIG. 7, an apparatus 700 for integratedly updating map data in the present embodiment may include: an acquisition module 701, a first-generation module 702 and a first updating module 703. The acquisition module 701 is configured to acquire map update data. The first-generation module 702 is configured to generate an updated confidence of map features based on the map update data. The first updating module 703 is configured to update uniformly a first-precision map and a second-precision map based on the updated confidence of the map features, where precision of the first-precision map is higher than precision of the second-precision map.

In the present embodiment, in the apparatus 700 for integratedly updating map data, for the specific processing and the technical effects of the acquisition unit 701, the first generation module 702 and the first updating module 703, reference may be made to the relevant description of steps 101-103 in the corresponding embodiment of FIG. 1, and detailed description thereof will be omitted.

In some alternative implementations of the present embodiment, the confidence includes a precision confidence; and the first-generation module 702 includes: a first-generation submodule, configured to generate an updated precision confidence of the map features, based on a non-updated precision confidence of the map features, precision of the map update data and data changes in the map update data.

In some alternative implementations of the present embodiment, the confidence includes a timeliness confidence; and the first-generation module 702 includes: an acquisition submodule, configured to acquire real-world changes; and a second-generation submodule, configured to generate an updated timeliness confidence of the map features, based on the map update data and the real-world changes.

In some alternative implementations of the present embodiment, the apparatus 700 for integratedly updating map data further includes: a second-generation module, configured to generate road topology data, based on the map update data; and a second updating module, configured to update the first-precision map and the second-precision map based on the road topology data.

In some alternative implementations of the present embodiment, the second updating module is further configured to: perform intersection segmentation based on the road topology data, and connect adjacent lane groups in series to form a conversion chain; extract geometric information of lane centerlines from the lane groups within the conversion chain, to generate a road fitting line of the second-precision map; associate an identification of a pre-update road segment of the second-precision map to the road fitting line; link an intersection connection relationship of the road fitting line in combination with intersection information; and restore information of at least part of map features of the second-precision map to the road fitting line.

In some alternative implementations of the present embodiment, the apparatus 700 for integratedly updating map data further includes: a transforming module, configured to perform association transformation on different map features of the first-precision map and the second-precision map, based on the map update data.

In some alternative implementations of the present embodiment, the map features include lane-level topology-associated features; and the transforming module includes: a third-generation submodule, configured to generate a connection relationship between lanes based on directional arrows in the map update data.

In some alternative implementations of the present embodiment, the map features include lane-level attribute features, and the lane-level attribute features include a lane-level speed limit and/or a lane-level marking style; and the transforming module includes: a fourth generation submodule, configured to generate a first lane-level speed limit and a second lane-level speed limit of the first-precision map based on a lane-level speed limit standard, and generate a first road-level speed limit of the second-precision map based on the first lane-level speed limit and the second lane-level speed limit, where the first lane-level speed limit is an upper limit of the lane-level speed limit, the second lane-level speed limit is a lower limit of the lane-level speed limit, and the first road-level speed limit is an upper limit of a road-level speed limit; and/or a fifth generation submodule, configured to generate traffic restrictions in combination with road network topology, and generate the lane-level marking style based on the traffic restrictions.

In the technical solution of the present disclosure, the collection, storage, use, processing, transmission, provision, and disclosure of the user personal information involved are all in compliance with the relevant laws and regulations, and do not violate public order and good customs.

According to an embodiment of the present disclosure, the present disclosure also provides an electronic device, a readable storage medium, and a computer program product.

FIG. 8 is a schematic block diagram of an exemplary electronic device 800 that may be used to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processor, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 8, the device 800 includes a computing unit 801, which may perform various appropriate actions and processing, based on a computer program stored in a read-only memory (ROM) 802 or a computer program loaded from a storage unit 808 into a random access memory (RAM) 803. In the RAM 803, various programs and data required for the operation of the device 800 may also be stored. The computing unit 801, the ROM 802, and the RAM 803 are connected to each other through a bus 804. An input/output (I/O) interface 805 is also connected to the bus 804.

A plurality of parts in the device 800 are connected to the I/O interface 805, including: an input unit 806, for example, a keyboard and a mouse; an output unit 807, for example, various types of displays and speakers; the storage unit 808, for example, a disk and an optical disk; and a communication unit 809, for example, a network card, a modem, or a wireless communication transceiver. The communication unit 809 allows the device 800 to exchange information/data with other devices over a computer network such as the Internet and/or various telecommunication networks.

The computing unit 801 may be various general-purpose and/or dedicated processing components having processing and computing capabilities. Some examples of the computing unit 801 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 801 performs the various methods and processes described above, such as a method for integratedly updating map data. For example, in some embodiments, a method for integratedly updating map data may be implemented as a computer software program, which is tangibly included in a machine readable medium, such as the storage unit 808. In some embodiments, part or all of the computer program may be loaded and/or installed on the device 800 via the ROM 802 and/or the communication unit 809. When the computer program is loaded into the RAM 803 and executed by the computing unit 801, one or more steps of a method for integratedly updating map data described above may be performed. Alternatively, in other embodiments, the computing unit 801 may be configured to perform a method for integratedly updating map data by any other appropriate means (for example, by means of firmware).

Various embodiments of the systems and technologies described above can be implemented in digital electronic circuit system, integrated circuit system, field programmable gate array (FPGA), application specific integrated circuit (ASIC), application special standard product (ASSP), system on chip (SOC), complex programmable logic device (CPLD), computer hardware, firmware, software, and/or combinations thereof. These various embodiments may include being implemented in one or more computer programs that may be executed and/or interpreted on a programmable system including at least one programmable processor, which may be a dedicated or general programmable processor that may receive data and instructions from a storage system, at least one input device, and at least one output device, and transmit data and instructions to the storage system, the at least one input device, and the at least one output device.

Program codes for implementing the method of the present disclosure may be written in any combination of one or more programming languages. These program codes may be provided to a processor or controller of a general purpose computer, special purpose computer or other programmable apparatus for data processing such that the program codes, when executed by the processor or controller, enables the functions/operations specified in the flowcharts and/or block diagrams being implemented. The program codes may execute entirely on the machine, partly on the machine, as a stand-alone software package partly on the machine and partly on the remote machine, or entirely on the remote machine or server.

In the context of the present disclosure, the machine readable medium may be a tangible medium that may contain or store programs for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, portable computer disk, hard disk, random access memory (RAM), read only memory (ROM), erasable programmable read only memory (EPROM or flash memory), optical fiber, portable compact disk read only memory (CD-ROM), optical storage device, magnetic storage device, or any suitable combination of the foregoing.

In order to provide interaction with the user, the systems and techniques described herein may be implemented on a computer having: a display device for displaying information to the user (e.g., a CRT (cathode ray tube) or LCD (liquid crystal display) monitor); a keyboard and a pointing device (e.g., mouse or trackball), through which the user can provide input to the computer. Other kinds of devices can also be used to provide interaction with users. For example, the feedback provided to the user may be any form of sensory feedback (e.g., visual feedback, auditory feedback, or tactile feedback); and the input from the user can be received in any form (including acoustic input, voice input or tactile input).

The systems and technologies described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which the user can interact with an implementation of the systems and technologies described herein), or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and generally interact with each other through a communication network. The relationship between the client and the server is generated by virtue of computer programs that run on corresponding computers and have a client-server relationship with each other. The server may be a cloud server, a distributed system server, or a server combined with blockchain.

It should be understood that the various forms of processes shown above may be used to reorder, add, or delete steps. For example, the steps disclosed in the present disclosure may be executed in parallel, sequentially, or in different orders, as long as the desired results of the technical solutions mentioned in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for integratedly updating map data, the method comprising:
acquiring map update data;
generating an updated confidence of map features based on the map update data; and
updating uniformly a first-precision map and a second-precision map based on the updated confidence of the map features, wherein precision of the first-precision map is higher than precision of the second-precision map.

2. The method according to claim 1, wherein the confidence comprises a precision confidence; and
the generating an updated confidence of map features based on the map update data, comprises:
generating an updated precision confidence of the map features, based on a non-updated precision confidence of the map features, precision of the map update data and data changes in the map update data.

3. The method according to claim 1, wherein the confidence comprises a timeliness confidence; and
the generating an updated confidence of map features based on the map update data, comprises:
acquiring real-world changes; and
generating an updated timeliness confidence of the map features, based on the map update data and the real-world changes.

4. The method according to claim 1, wherein the method further comprises:
generating road topology data, based on the map update data; and
updating the first-precision map and the second-precision map based on the road topology data.

5. The method according to claim 4, wherein the updating the first-precision map and the second-precision map based on the road topology data, comprises:
performing intersection segmentation based on the road topology data, and connecting adjacent lane groups in series to form a conversion chain;
extracting geometric information of lane centerlines from the lane groups within the conversion chain, to generate a road fitting line of the second-precision map;
associating an identification of a non-updated road segment of the second-precision map to the road fitting line;
linking an intersection connection relationship of the road fitting line in combination with intersection information; and
restoring information of at least part of map features of the second-precision map to the road fitting line.

6. The method according to claim 1, wherein the method further comprises:
performing association transformation on different map features of the first-precision map and the second-precision map, based on the map update data.

7. The method according to claim 6, wherein the map features comprise lane-level topology-associated features; and
the performing association transformation on different features of the first-precision map and the second-precision map, based on the map update data, comprises:
generating a connection relationship between lanes based on directional arrows in the map update data.

8. The method according to claim 6, wherein the map features comprise lane-level attribute features, and the lane-level attribute features comprise a lane-level speed limit and/or a lane-level marking style; and
the performing association transformation on different features of the first-precision map and the second-precision map, based on the map update data, comprises:
generating a first lane-level speed limit and a second lane-level speed limit of the first-precision map based on a lane-level speed limit standard, and generating a first road-level speed limit of the second-precision map based on the first lane-level speed limit and the second lane-level speed limit, wherein the first lane-level speed limit is an upper limit of the lane-level speed limit, the second lane-level speed limit is a lower limit of the lane-level speed limit, and the first road-level speed limit is an upper limit of a road-level speed limit; and/or
generating traffic restrictions in combination with road network topology, and generating the lane-level marking style based on the traffic restrictions.

9. An electronic device, comprising:
at least one processor; and
a memory communicatively connected to the at least one processor; wherein,
the memory stores instructions executable by the at least one processor, and the instructions, when executed by the at least one processor, cause the at least one processor to perform operations comprising:
acquiring map update data;
generating an updated confidence of map features based on the map update data; and
updating uniformly a first-precision map and a second-precision map based on the updated confidence of the map features, wherein precision of the first-precision map is higher than precision of the second-precision map.

10. The electronic device according to claim 9, wherein the confidence comprises a precision confidence; and
the generating an updated confidence of map features based on the map update data, comprises:
generating an updated precision confidence of the map features, based on a non-updated precision confidence of the map features, precision of the map update data and data changes in the map update data.

11. The electronic device according to claim 9, wherein the confidence comprises a timeliness confidence; and
the generating an updated confidence of map features based on the map update data, comprises:
acquiring real-world changes; and
generating an updated timeliness confidence of the map features, based on the map update data and the real-world changes.

12. The electronic device according to claim 9, wherein the operations further comprise:
generating road topology data, based on the map update data; and
updating the first-precision map and the second-precision map based on the road topology data.

13. The electronic device according to claim 12, wherein the updating the first-precision map and the second-precision map based on the road topology data, comprises:
performing intersection segmentation based on the road topology data, and connecting adjacent lane groups in series to form a conversion chain;
extracting geometric information of lane centerlines from the lane groups within the conversion chain, to generate a road fitting line of the second-precision map;
associating an identification of a non-updated road segment of the second-precision map to the road fitting line;
linking an intersection connection relationship of the road fitting line in combination with intersection information; and
restoring information of at least part of map features of the second-precision map to the road fitting line.

14. The electronic device according to claim 9, wherein the operations further comprise:
performing association transformation on different map features of the first-precision map and the second-precision map, based on the map update data.

15. The electronic device according to claim 14, wherein the map features comprise lane-level topology-associated features; and
the performing association transformation on different features of the first-precision map and the second-precision map, based on the map update data, comprises:
generating a connection relationship between lanes based on directional arrows in the map update data.

16. The electronic device according to claim 14, wherein the map features comprise lane-level attribute features, and the lane-level attribute features comprise a lane-level speed limit and/or a lane-level marking style; and
the performing association transformation on different features of the first-precision map and the second-precision map, based on the map update data, comprises:
generating a first lane-level speed limit and a second lane-level speed limit of the first-precision map based on a lane-level speed limit standard, and generating a first road-level speed limit of the second-precision map based on the first lane-level speed limit and the second lane-level speed limit, wherein the first lane-level speed limit is an upper limit of the lane-level speed limit, the second lane-level speed limit is a lower limit of the lane-level speed limit, and the first road-level speed limit is an upper limit of a road-level speed limit; and/or
generating traffic restrictions in combination with road network topology, and generating the lane-level marking style based on the traffic restrictions.

17. A non-transitory computer readable storage medium storing computer instructions, wherein, the computer instructions, when executed by a computer, cause the computer to perform operations comprising:
acquiring map update data;
generating an updated confidence of map features based on the map update data; and
updating uniformly a first-precision map and a second-precision map based on the updated confidence of the map features, wherein precision of the first-precision map is higher than precision of the second-precision map.

18. The storage medium according to claim 17, wherein the confidence comprises a precision confidence; and
the generating an updated confidence of map features based on the map update data, comprises:
generating an updated precision confidence of the map features, based on a non-updated precision confidence of the map features, precision of the map update data and data changes in the map update data.

19. The storage medium according to claim 17, wherein the confidence comprises a timeliness confidence; and
the generating an updated confidence of map features based on the map update data, comprises:
acquiring real-world changes; and
generating an updated timeliness confidence of the map features, based on the map update data and the real-world changes.

20. The storage medium according to claim 17, wherein the operations further comprise:
generating road topology data, based on the map update data; and
updating the first-precision map and the second-precision map based on the road topology data.
